(19) United States
(12) Patent Application Publication
(10) Pub. No.: US 2017/0129393 A1
(43) Pub. Date: May 11, 2017

(54) VEHICLE LIGHTING ASSEMBLY HAVING RETRACTABLE COVER PROVIDING A LIGHTED IMAGE

(71) Applicant: Ford Global Technologies, LLC, Dearborn, MI (US)

(72) Inventors: Aaron Bradley Johnson, Allen Park, MI (US); Stuart C. Salter, White Lake, MI (US); Stephen Kenneth Helwig, Farmington Hills, MI (US); Paul Kenneth Dellock, Northville, MI (US)

(73) Assignee: Ford Global Technologies, LLC

(21) Appl. No.: 14/934,561

(22) Filed: Nov. 6, 2015

(51) Int. Cl. B60Q 1/14; B60Q 1/04; B60Q 1/00

(52) U.S. Cl. CPC B60Q 1/1438; B60Q 1/0076; B60Q 1/04

(57) ABSTRACT

A vehicle lighting assembly configured as a headlamp is provided. The vehicle lighting assembly includes a housing defining a light output window and a light source arranged to direct light through the light output window. The vehicle lighting assembly also includes a retractable cover actuatable between open and closed positions. The cover covers the light output window in the closed position to define a light image pattern for light output.

### FIELD OF THE INVENTION

The present invention generally relates to a vehicle lighting assembly, and more particularly relates to a retractable cover for a vehicle lighting assembly that produces a lighted image.

### BACKGROUND OF THE INVENTION

Automotive vehicles are typically equipped with a plurality of lighting assemblies for generating light illumination. Typically included on a vehicle is a pair of vehicle headlights or headlamps which project light forward of the vehicle and onto the roadway to enable nighttime driving. The headlamp assembly typically includes one or more lightbulbs or light emitting diodes (LEDs) positioned behind a lens within a housing and mounted to the front side of the vehicle. It would be desirable to provide for enhanced vehicle lighting systems that offer additional lighting functions.

### SUMMARY OF THE INVENTION

According to one aspect of the present invention, a vehicle lighting assembly is provided. The vehicle lighting assembly includes a housing defining a light output window, a light source arranged to direct light through the light output window, and a retractable cover actuatable between an open position exposing the light output window and a closed output position covering the light output window to define a lighted image pattern.

According to another aspect of the present invention, a vehicle headlamp assembly is provided. The vehicle headlamp assembly includes a bezel defining a light output window, and a light source arranged to direct light through the window. The vehicle headlamp assembly also includes a retractable cover actuatable between an open position and a closed position covering the window to define a lighted image pattern, and an actuator for actuating the retractable cover between the open and closed positions.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a front perspective view of a vehicle equipped with a vehicle headlamp assembly having a retractable cover, according to one embodiment;

FIG. 2 is an enlarged front view of the headlamp assembly illustrating the retractable cover in the closed position;

FIG. 3 is an enlarged front view of the headlamp assembly illustrating the retractable cover in the open position;

FIG. 4 is a front perspective view of the headlamp assembly shown with the retractable cover in the closed position;

FIG. 5 is a rear view of the headlamp assembly with the retractable cover in the closed position;

FIG. 5A is an enlarged perspective view of a gear linkage for actuating the retractable cover and shown in the closed position;

FIG. 6 is a rear perspective view of the headlamp assembly with the retractable cover in the open position;

FIG. 6A is an enlarged perspective view of the gear linkage shown in the cover open position;

FIG. 7 is a top view of the headlamp assembly with the retractable cover assembly shown in the open position;

FIG. 8 is a top view of the headlamp assembly with the retractable cover assembly shown in the closed position; and

FIG. 9 is a rear perspective view of the retractable cover assembly further illustrating a bias spring arrangement, according to another embodiment.

### DETAILED DESCRIPTION OF THE PREFERRED EMBODIMENTS

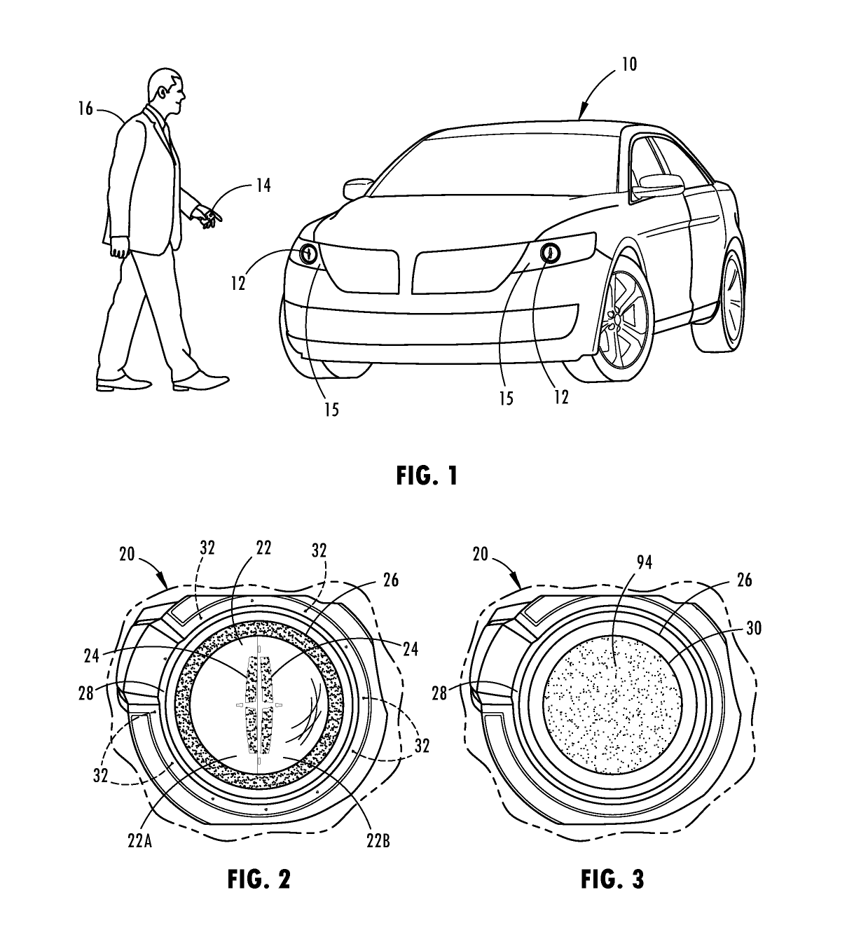

Referring to FIGS. 1-3, an automotive wheeled vehicle 10 is generally illustrated equipped with a pair of lighting assemblies 12 for providing vehicle exterior lighting. In the embodiment shown, the lighting assemblies 12 are configured as headlight or headlamp assemblies positioned near the front side near opposite corners of the vehicle 10. The lighting assemblies 12 provide exterior lighting for the vehicle 10 such as high and low beam headlight illumination that project light forward of the vehicle 10 and onto the roadway. It should be appreciated that the lighting assemblies 12 may be located at other locations on the vehicle 10 and may be configured to provide other lighting functions such as a taillight, a turn light, a fog light, a daytime running light, or other lighting functions.

A vehicle operator (person) 16 is further shown in FIG. 1 approaching the vehicle 10 and possessing a key fob 14 for accessing the vehicle 10 and controlling various vehicle functions. The key fob 14 may be activated by the operator to lock and unlock the vehicle 10, start the vehicle 10, sound a vehicle alarm, unlatch/open or latch/close one or more access doors on the vehicle and control other remote controlled functions. In addition, the vehicle 10 may sense the distance between the vehicle 10 and the key fob 14 and determine if the key fob 14 and the operator 16 possessing the key fob 14 are approaching the vehicle 10 and/or within a certain distance of the vehicle 10. The distance between the key fob 14 and the vehicle 10 may be determined based on the magnitude of a transmitted signal associated with the key fob 14, according to one embodiment. According to other embodiments, the vehicle 10 may be equipped with one or more proximity sensors such as ultrasonic sensors, capacitive sensors, cameras, or other sensors for determining the distance between a person, such as an operator 16, and the vehicle 10.

The vehicle lighting assembly 12 is equipped with a retractable cover assembly 20 having a retractable cover 22 that is actuatable between a closed position shown in FIG. 2 and an open position shown in FIG. 3. The retractable cover 22, also referred to as a retractable shield, substantially covers or shields a light output window 30 of the lighting assembly 12 when the retractable cover 22 is in the closed position. The retractable cover 22 includes an image pattern formed therein for defining a lighted image when the retractable cover 22 is in the closed position. The image pattern may be formed by one or more image pattern openings 24 formed within the retractable cover 22 that define a desired image pattern through which light generated by a light source may illuminate and be viewed from outside the vehicle 10. When the retractable cover 22 is in the closed position as seen in FIG. 2, light produced within the lighting assembly 12 illuminates and exits the image pattern openings 24 defining the lighted image pattern. Accordingly, a lighted image pattern is output from the image pattern openings 24. It should be appreciated that the retractable cover 22 may be actuated to the closed position to provide an illuminated image pattern when the vehicle headlights are not required for vehicle operation, such as when the operator 16 is sensed outside the vehicle 10 and approaching the vehicle 10 within a predetermined distance or when the vehicle 10 is driven in the daylight without the need for headlights. When the vehicle lighting assembly 12 is required to operate as a headlight to light and illuminate the roadway in front of the vehicle 10, the retractable cover 22 is actuated to the open position to leave the light output window 30 exposed or unobstructed by the retractable cover 22 as shown in FIG. 3.

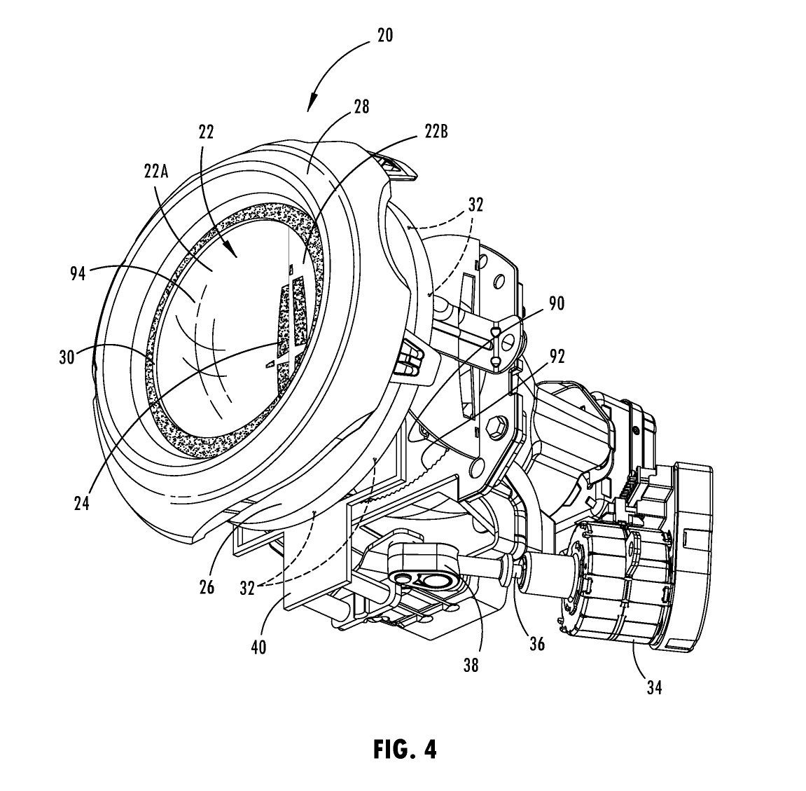

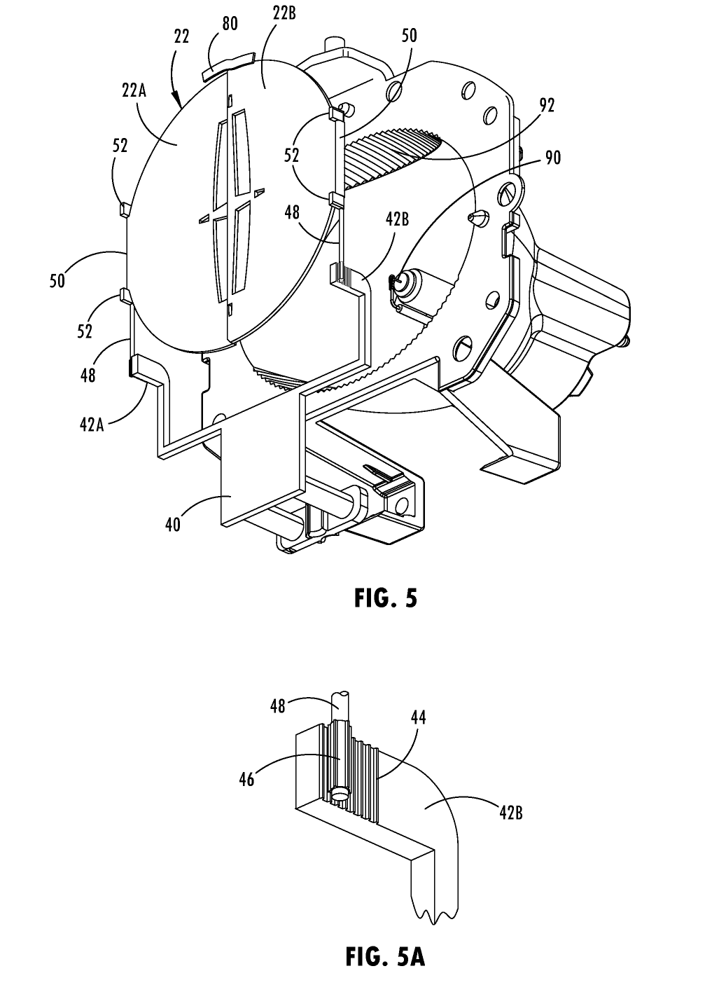

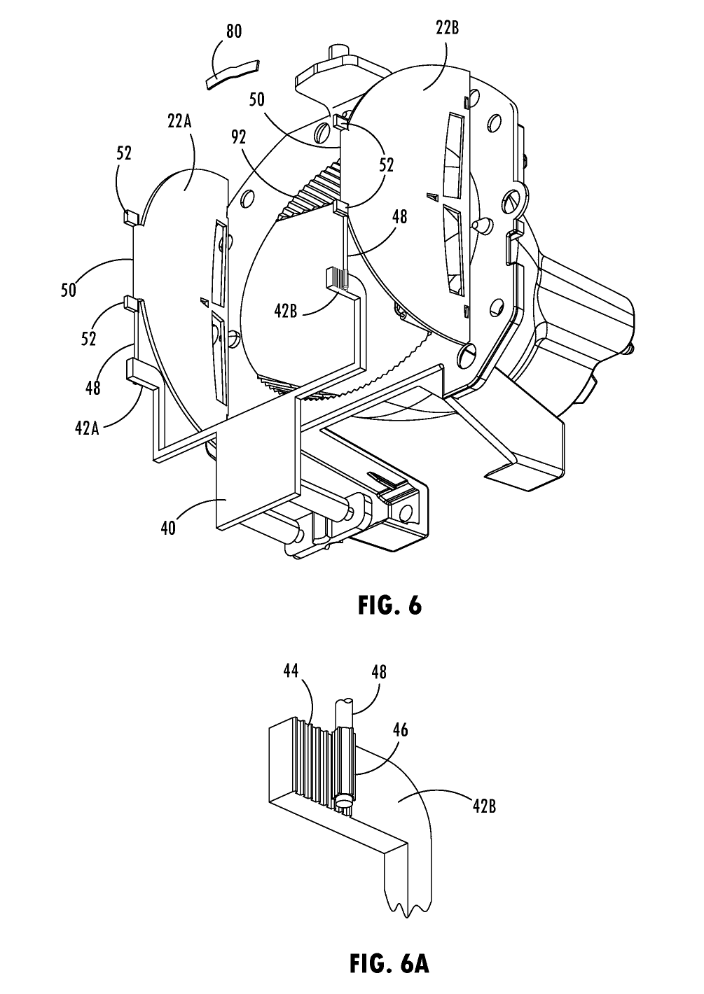

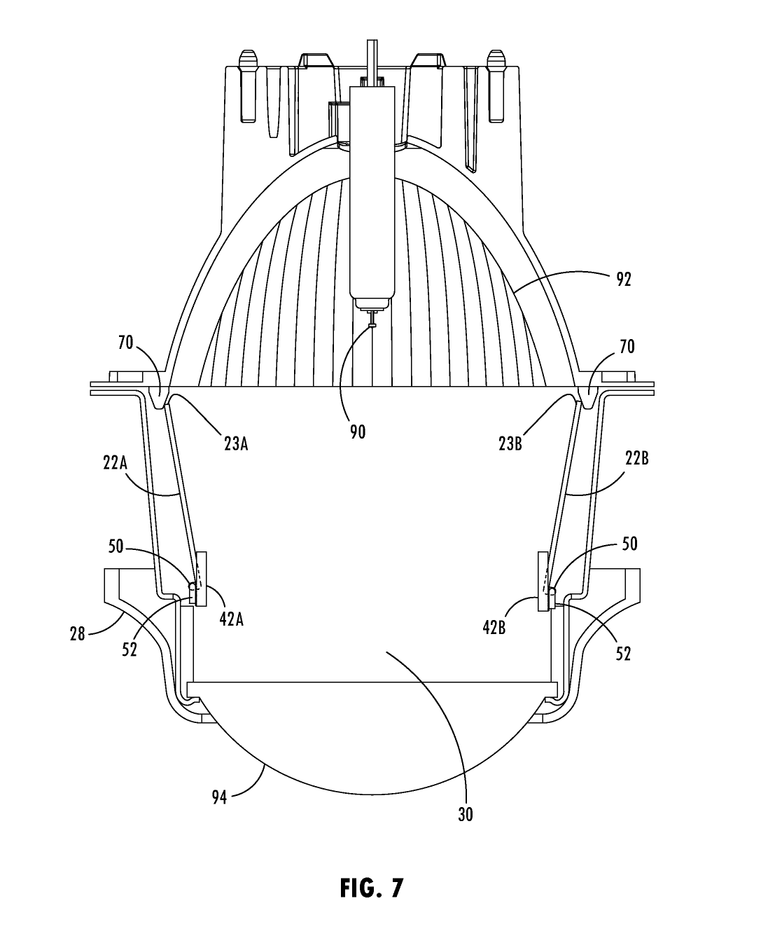

The retractable cover 22 includes a first pivoting door 22A and a second pivoting door 22B, both of which pivot about respective hinges 50 located on opposite sides of the light output window 30 as seen in FIGS. 5 and 6, according to one embodiment. As seen in FIGS. 4-8, the vehicle lighting assembly 12 includes a housing 28 which generally defines a circular bezel at the front side of the lighting assembly 12 through which light output from one or more light sources may be transmitted within the light output window 30. The housing 28 generally defines and contains an interior of the lighting assembly 12 which includes one or more light sources 90 in the form of one or more incandescent or halogen bulbs or a plurality of light emitting diodes (LEDs). Light generated by the light source(s) 90 passes generally unimpeded through the light output window 30 of the housing 28 to the outside environment when the retractable cover 22 is in the open position. The lighting assembly 12 may further include a reflector 92, such as a parabolic reflector, generally located behind the light source 90. Additionally, the lighting assembly 12 has an inner condenser lens 94 extending across the light output window 30 at the front of the housing 28 forward of the light source(s) 90 and the retractable cover 22. The inner condenser lens 94 may concentrate and collect the light that passes through the light output window 30. The lighting assembly 12 also includes a transparent outer lens cover 15 covering the front side of the housing 28 as seen in FIG. 1.

The retractable cover 22 includes first and second retractable doors 22A and 22B which pivot about hinges 50 on opposite sides of the housing 28 proximate to the light output window 30. The retractable cover 22 is actuatable by an actuator 34 to pivot the retractable doors 22A and 22B between open and closed positions. The actuator 34 may include an electric stepper motor, according to one embodiment. The stepper motor has an output shaft 36 which drives a gearbox 38 to translate rotational motion to a linear motion. The gearbox 38 is connected to a bracket 40 which moves linearly in response to actuation by the actuator 34. The bracket 40 includes a pair of upstanding arms 42A and 42B which translate forward and backwards in concert with the movement of the bracket 40 to close and open the retractable cover 22. Each arm 42A and 42B includes an array of teeth 44 that engage a rotatable toothed gear 46 on a rotary shaft 48. As a result, linear motion of the arms 42A and 42B translates the motion to rotational motion of the rotary shaft 48 which forms a hinge 50 for pivoting the respective retractable doors 22A and 22B. The hinges 50 each have housings 52 supported on opposite ends and rotate in concerts with rotary shaft 48. Rotation of the hinges 50 causes rotation and hence pivoting of the corresponding retractable doors 22A and 22B between the open and closed positions. According to one example, the retractable doors 22A and 22B are rotated at least 90° and may be rotated approximately 100° between the open and closed positions.

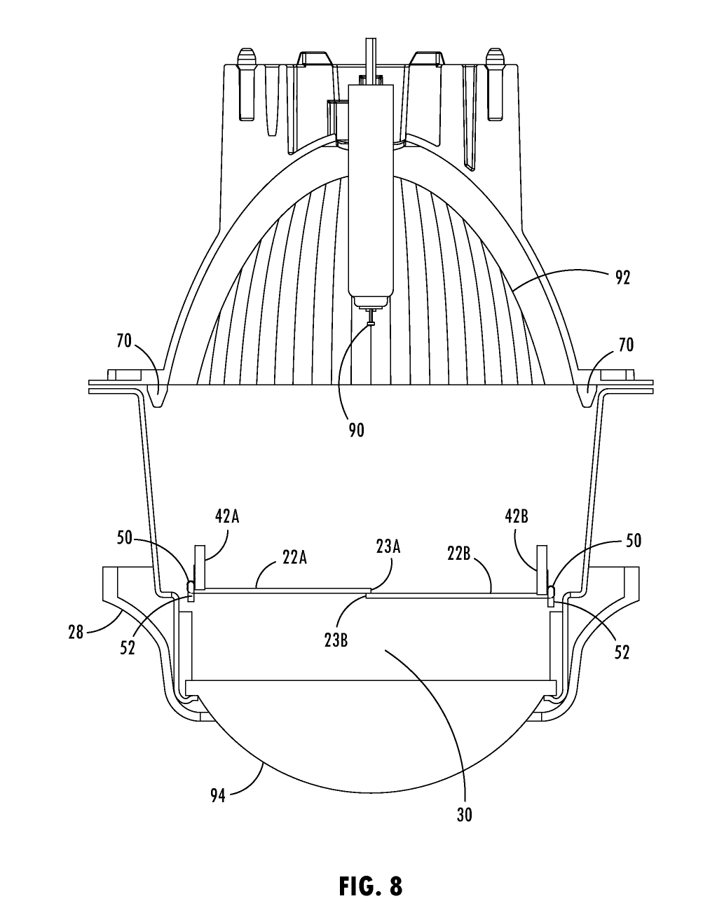

In the open position shown in FIG. 7, both of the retractable doors 22A and 22B pivot inward and expose unobstructively the light source 90 to the light output window 30 and the inner condenser lens 94 at the front of the housing 28. In this position, the retractable doors 22A and 22B abut door stops 70 which prevent further outward movement and help prevent rattling of the retractable doors 22A and 22B during vehicle movement. In the closed position shown in FIG. 8, the first and second retractable doors 22A and 22B substantially close off the light output window 30 within the housing 28 with the exception of the image pattern openings 24 formed therein. As such, light is able to be transmitted through the image pattern openings 24. The first (inboard) and second (outboard) retractable doors 22A and 22B overlap at inner edges 23A and 23B, respectively, as shown in FIG. 8. In the closed position, light may illuminate through the image pattern opening(s) 24 to produce as an output a lighted image. By providing the overlap along the edges 23A and 23B, the leakage of light output between the first and second retractable doors 22A and 22B is minimized.

According to one embodiment, the light source 90 may include a projector lamp that projects light in a desired light beam pattern. In the headlamp embodiment, the projector lamp produces a light beam for use as a headlight. However, it should be appreciated that the light source 90 may include other forms of light generators. The light source 90 may operate at full power for headlight use and at a reduced power, e.g., fifty percent (50%), for illuminating the image pattern in the closed position of the retractable cover 22, according to one embodiment. In another embodiment, the vehicle light assembly 20 may include a light ring 26 that generally extends around an inside circumference of the housing 28 within the bezel. The light ring 26 may include one or more light sources 32, such as LEDs, for illuminating the light ring 26. In one example, the ring has twelve (12) LEDs spaced around the ring light 26. The light ring 26 may be light translucent to transmit light and may form a light blade that transmits light from the light ring 26 into the interior of the housing 28 for illumination through the image pattern openings 24 in the retractable cover 22 when in a closed position. The light ring 26 may also illuminate light on the front side of the light ring 26 to provide an illuminated perimeter of the light output window 30. The light source 90 for the lighting assembly 12 may be employed at a reduced power, e.g., fifty percent (50%) to provide illumination and/or the light ring 26 may provide illumination via light sources 32 when the retractable cover 22 is in the closed position.

Additionally, it should be appreciated that a switch 80 may be provided within the housing 28 to detect when the retractable cover 22 is in either the open position or closed position and to control activation of the light ring 26 and/or light source 90 for illuminating the image pattern opening(s) 24 when the retractable cover 22 is in the closed position. The switch 80 may include a sensor for detecting the closed position of the retractable cover 22 and may also serve as a stop member to limit the inward pivoting of the retractable doors 22A and 22B at the closed position. According to one embodiment, the switch 80 may be located within the bezel of the housing 28 to detect the retractable cover 22 in the closed position as seen in FIG. 4 and may activate the light source 90 at reduced power or the light ring 26 in response thereto. Upon movement of the retractable cover 22 to the open position, the switch 80 may turn off the light ring 26 or adjust the light source 90 to full power for use as a headlight.

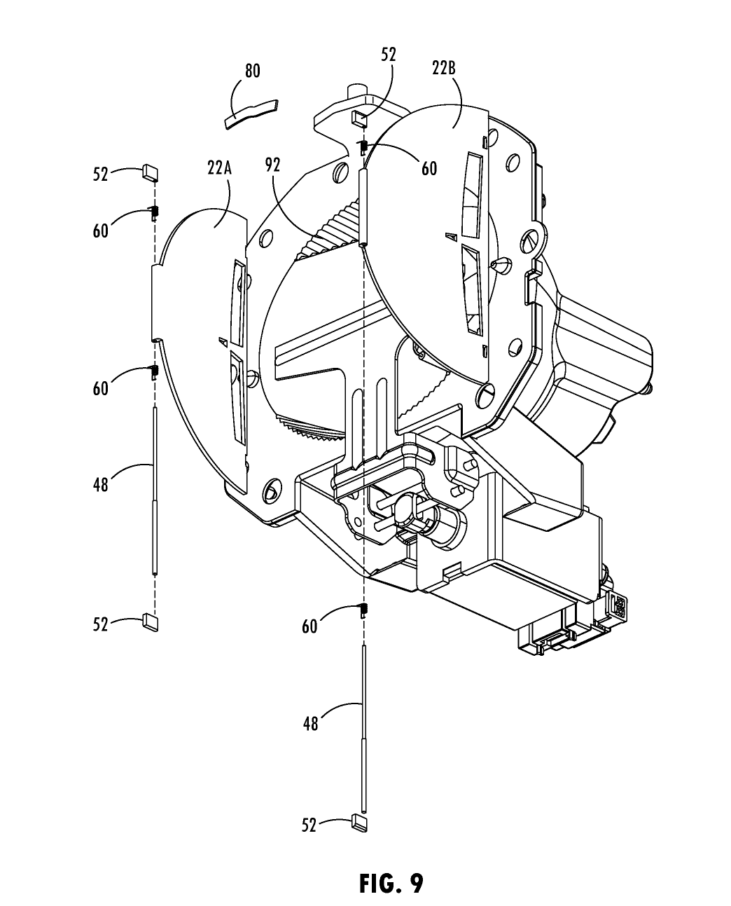

The retractable cover assembly 20 may be configured to operate, such that the retractable cover 22 is in a normally open position which enables unobstructive operation of the headlights. According to one embodiment, one or more bias springs 60 may be operatively coupled to the retractable cover 22 to bias the retractable cover 22 with a bias force into the open position as shown in FIG. 9. In the embodiment shown, the bias springs 60 may include coil springs that are disposed within each of the two housings 54 located at opposite ends of hinge 50 for each of the retractable doors 22A and 22B. The bias spring 60 in each housing 52 is positioned to bias the retractable doors 22A or 22B to the normally open position as shown in FIG. 9. It should be appreciated that the retractable cover assembly 20 may include other bias mechanisms, such as one or more springs configured to bias the retractable doors 22A and 22B to a normally open position. When the retractable cover 22 is desired to be moved to the closed position, an actuator 34, such as a motor or solenoid, may be activated to overcome the force of the bias springs 60 to actuate the retractable cover 22 to the closed position. Therefore, in the event of a failure of the retractable cover assembly 20 or a power failure affecting the actuator 34, the retractable cover 22 will remain in the open and unobstructed position and usable for normal headlight functions.

According to one embodiment, the lighted image may be a logo or emblem of the vehicle 10 that is readily recognizable. Any of a number of shapes and sizes of the image pattern opening(s) 24 may be provided. Additionally, any of the vehicle exterior lights may be configured to include the retractable cover assembly 20. The image pattern openings 24 may be formed in one or more members of the retractable cover 22. The retractable cover 22 may be made of a metal or other material. While the retractable cover 22 is shown and described herein as having first and second pivoting doors 22A and 22B, it should be appreciated that other configurations of a retractable cover 22 may be employed, such as one or more sliding doors for moving between an open and closed positions. Further, it should be appreciated that the lighted image pattern may be formed by a translucent material formed within the retractable cover 22, according to another embodiment.

Accordingly, the vehicle light assembly 12 advantageously may be operated to close the retractable cover 22 via the actuator 34 and activate the light source 90 and/or light ring 26 to provide a lighted image pattern through the image pattern opening(s) 24 in the retractable cover 22 in the closed position. This may be desirable when the operator 16 of the vehicle 10 is approaching the vehicle 10 and is within a predetermined distance of the vehicle 10 as sensed by the location of the key fob or other sensor(s). Additionally, the vehicle light assembly 12 may operate to generate the lighted image when the vehicle 10 is driven during daylight times or at other times when full headlight lighting is not required. As such, the lighted image seen in the closed position of the retractable cover 22 provides a styling feature to the vehicle 10.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A vehicle lighting assembly comprising:
a housing defining a light output window;
a light source arranged to direct light through the light output window; and
a retractable cover actuatable between an open position exposing the light output window and a closed position covering the light output window to define a lighted image pattern.

2. The vehicle lighting assembly of claim 1, wherein the lighting assembly is used as a headlamp and the housing comprises a bezel that defines the light output window.

3. The vehicle lighting assembly of claim 1, wherein the retractable cover comprises first and second pivoting doors that pivot between the open position and the closed position.

4. The vehicle lighting assembly of claim 3, wherein the first and second doors overlap along an edge in the closed position.

5. The vehicle lighting assembly of claim 1, wherein the light source comprises a projector lamp.

6. The vehicle lighting assembly of claim 1, wherein the cover has one or more image defining openings defining a shape of the lighted image pattern.

7. The vehicle lighting assembly of claim 1, wherein the retractable cover is actuated by an actuator.

8. The vehicle lighting assembly of claim 7, wherein the retractable cover is spring biased by a spring and is actuated by the actuator.

9. The vehicle lighting assembly of claim 8, wherein the spring biases the cover to the closed position, and wherein the actuator actuates the cover to the open position.

10. The vehicle lighting assembly of claim 1 further comprising a light ring disposed within the housing for generating light when the cover is in the closed position.

11. The vehicle lighting assembly of claim 10 further comprising a switch actuatable by the cover in one of the open and closed positions to activate the light ring when the cover is in the closed position.

12. A vehicle headlamp assembly comprising:
a bezel defining a light output window;
a light source arranged to direct light through the window;
a retractable cover actuatable between an open position and a closed position covering the window to define a lighted image pattern; and
an actuator for actuating the retractable cover between the open and closed positions.

13. The vehicle headlamp assembly of claim 12, wherein the retractable cover comprises first and second pivoting doors that pivot between the open position and the closed position.

14. The vehicle headlamp assembly of claim 13, wherein the first and second doors overlap along an edge in the closed position.

15. The vehicle headlamp assembly of claim 12, wherein the light source comprises a projector lamp.

16. The vehicle headlamp assembly of claim 12, wherein the cover has one or more image defining openings.

17. The vehicle headlamp assembly of claim 12, wherein the retractable cover is spring biased by a spring.

18. The vehicle headlamp assembly of claim 17, wherein the spring biases the cover to the closed position, and wherein the actuator opens the cover when energized.

19. The vehicle headlamp assembly of claim 12 further comprising a light ring disposed within the housing for generating light in the closed position.

20. The vehicle headlamp assembly of claim 19 further comprising a switch actuatable by the cover in one of the open and closed positions to activate the light ring when the cover is in the closed position.
